(19) United States
(12) Patent Application Publication
(10) Pub. No.: US 2024/0029756 A1
(43) Pub. Date: Jan. 25, 2024

(54) METHOD AND APPARATUS FOR DYNAMIC DIRECITONAL VOICE RECEPTION WITH MULTIPLE MICROPHONES

(71) Applicant: Dell Products, LP, Round Rock, TX (US)

(72) Inventors: Peng Lip Goh, Singapore (SG); Eng Kang Chng, Singapore (SG); Fook Sin Choo, Singapore (SG); Deeder M. Aurongzeb, Austin, TX (US)

(73) Assignee: Dell Products, LP, Round Rock, TX (US)

(21) Appl. No.: 17/872,878

(22) Filed: Jul. 25, 2022

(51) Int. Cl. G10L 25/60; G10L 25/84; G10L 15/08; H04R 5/027

(52) U.S. Cl. CPC G10L 25/60; G10L 25/84; G10L 15/083; H04R 5/027

(57) ABSTRACT

A speakerphone may include a memory device, a PMU, a first microphone, a second microphone, and a third microphone, each, to receive audio waves. The speakerphone also includes a DSP to process the audio waves received by the first microphone, second microphone, and third microphone to determine the wave phases of the audio waves received by the first microphone, second microphone, and third microphone to calculate a direction of a voice of a user relative to the speakerphone, lock in the voice direction of the user relative to the speakerphone, and process the voice of the user to detect characteristics of the user's voice and filter out background noises and background voices from outside an angular field coverage for the voice direction of the user.

### FIELD OF THE DISCLOSURE

The present disclosure generally relates to speakerphones. The present disclosure more specifically relates to optimizing voice detection at a speakerphone.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include or be operatively coupled to a speakerphone used to conduct a conversation between remote users.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system with a speakerphone according to an embodiment of the present disclosure;

FIG. 2 is a graphic diagram of a speakerphone according to an embodiment of the present disclosure;

FIG. 3 is a graphic diagram of a top view of a speakerphone according to another embodiment of the present disclosure;

FIG. 4 is a graphic diagram of a top view of a speakerphone according to another embodiment of the present disclosure;

FIG. 5 is a diagram describing a method of detecting and processing speech, via a digital signal processor (DSP) and the execution of a trained acoustic model, from a user captured by a plurality of microphones of the speakerphone according to an embodiment of the present disclosure; and

FIG. 6 is a flow diagram of a method of operating a speakerphone with directional voice reception according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Speakerphones allow users to communicate with remote participants of a conversation conducted at the speakerphone. In an embodiment, this speakerphone may act as a peripheral device operatively coupled to an information handling system. In the present specification and in the appended claims, a speakerphone includes any device that may be used, for example, during a teleconference meeting and allows any number of users to conduct a conversation with one or more other users remote from the speakerphone. These other users remote from the speakerphone may also have a speakerphone used to engage in the conversation in an embodiment. In an embodiment, an internet connection or phone connection (e.g., voice over internet protocol (VOIP)) may facilitate transmission of audio data to remote users and from the speakerphone described herein.

During operation of the speakerphone, all user's voices may be heard simultaneously. This may be as intended in those situations where all participants are expected to provide comments during the conversation or at least be provided with such an opportunity in a multi-user mode. However, there may arise certain situations where one user is intending to conduct a conversation with other remote user(s) via the speakerphone and other, non-participating people are casually talking in the background. This background noise (e.g., human voices, animal noises such as dogs, traffic, etc.) may contribute to the unwanted noise during the discussion. Although artificial intelligence (AI) noise reduction algorithms are able to filter out this background noise, those types of systems that employ AI algorithms are unable to distinguish between the user's human voice and other human voices in the background when filtering out other background noises.

The present specification describes a speakerphone that includes a memory device and a power management unit (PMU). The speakerphone further includes a first microphone, a second microphone, and a third microphone that each receive audio waves to detect a user's voice. The speakerphone includes a capacitive touch input or button input to select between a multiuser mode and a single-user mode. In a single-user mode, the speakerphone uses a digital signal processor (DSP) to further process the audio waves received by the first microphone, second microphone, and third microphone to determine the wave phases of the audio waves received by the first microphone, second microphone, and third microphone to calculate a direction of a voice of a user relative to the speakerphone. The DSP further locks in the direction of the user relative to the speakerphone. The DSP, in an embodiment, may also process the voice of the user to detect characteristics of the user's voice and filter out background noises and background voices. The characteristics of the user's voice, in an embodiment, may be saved within a user voice database for the speakerphone to recognize the user's voice.

In an embodiment, the characteristics of the user's voice may include an amplitude of the user's voice, a frequency of the user's voice, a pitch of the user's voice, a tone of the user's voice, and pitch duration of the user's voice. The pitch duration of a user's voice may be described as a duration between successive pitch marks in the user's voice.

In an embodiment, the DSP may further detect an amplitude of a user's voice and, based on changes in the amplitude, determine whether a user's position has changed. The changes in the amplitude may be monitored by each microphone and detected by any give microphone. In an embodiment, where any microphone detects that the amplitude of the user's voice has dropped below an amplitude threshold, the DSP may begin to process the audio waves received by the first microphone, second microphone, and third microphone to recalculate a direction of a voice of a user relative to the speakerphone. In an embodiment, a light-emitting diode (LED) strip indicates an angular field coverage including the direction of where the user's voice is detected.

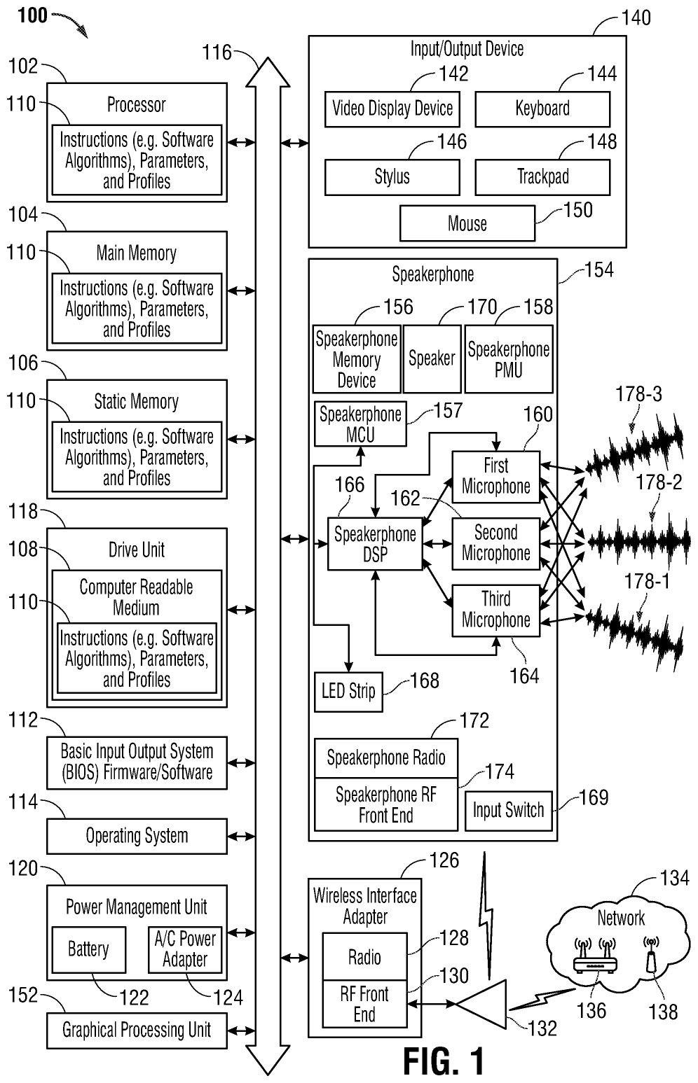

FIG. 1 illustrates an information handling system 100 similar to information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a convertible laptop, a tablet, a smartphone, a communications device, an access point (AP), a base station transceiver, a wireless telephone, a control system, a camera, a scanner, a printer, a personal trusted device, a web appliance, or any other suitable machine capable of executing a set of instructions (sequential or otherwise) that specify actions to be taken by that machine, and can vary in size, shape, performance, price, and functionality.

In a networked deployment, the information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, an information handling system 100 may be any mobile or other computing device capable of executing a set of instructions (sequential or otherwise) that specify actions to be taken by that machine. In an embodiment, the information handling system 100 may be operatively coupled to a server or other network device as well as with any other network devices such as a speakerphone 154. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include memory (volatile (e.g., random-access memory, etc.), nonvolatile (read-only memory, flash memory etc.) or any combination thereof), one or more processing resources, such as a central processing unit (CPU), a graphics processing unit (GPU) 152, processing, hardware, controller, or any combination thereof. Additional components of the information handling system 100 can include one or more storage devices, one or more communications ports for communicating with external devices, as well as various input and output (I/O) devices 140, such as a keyboard 144, a mouse 150, a video display device 142, a stylus 146, a trackpad 148, a speakerphone 154, or any combination thereof. The information handling system 100 can also include one or more buses 116 operable to transmit data communications between the various hardware components described herein. Portions of an information handling system 100 may themselves be considered information handling systems and some or all of which may be wireless.

Information handling system 100 can include devices or modules that embody one or more of the devices or execute instructions for the one or more systems and modules described above, and operates to perform one or more of the methods described herein. The information handling system 100 may execute code instructions 110 via processing resources that may operate on servers or systems, remote data centers, or on-box in individual client information handling systems according to various embodiments herein. In some embodiments, it is understood any or all portions of code instructions 110 may operate on a plurality of information handling systems 100.

The information handling system 100 may include processing resources such as a processor 102 such as a central processing unit (CPU), accelerated processing unit (APU), a neural processing unit (NPU), a vision processing unit (VPU), an embedded controller (EC), a digital signal processor (DSP), a GPU 152, a microcontroller, or any other type of processing device that executes code instructions to perform the processes described herein. Any of the processing resources may operate to execute code that is either firmware or software code. Moreover, the information handling system 100 can include memory such as main memory 104, static memory 106, computer readable medium 108 storing instructions 110 of, in an example embodiment, an audio application, or other computer executable program code, and drive unit 118 (volatile (e.g., random-access memory, etc.), nonvolatile (read-only memory, flash memory etc.) or any combination thereof).

As shown, the information handling system 100 may further include a video display device 142. The video display device 142, in an embodiment, may function as a liquid crystal display (LCD), an organic light emitting diode (OLED), a flat panel display, or a solid-state display. Although FIG. 1 shows a single video display device 142, the present specification contemplates that multiple video display devices 142 may be used with the information handling system to facilitate an extended desktop scenario, for example. Additionally, the information handling system 100 may include one or more input/output devices 140 including an alpha numeric input device such as a keyboard 144 and/or a cursor control device, such as a mouse 150, touchpad/trackpad 148, a stylus 146, an earpiece that provides audio output to a user, a speakerphone 154 that provides audio input and output so a user may communicate with a remote user, or a gesture or touch screen input device associated with the video display device 142 that allow a user to interact with the images, windows, and applications presented to the user. In an embodiment, the video display device 142 may provide output to a user that includes, for example, one or more windows describing one or more instances of applications being executed by the processor 102 of the information handling system. In this example embodiment, a window may be presented to the user that provides a graphical user interface (GUI) representing the execution of that application.

The network interface device of the information handling system 100 shown as wireless interface adapter 126 can provide connectivity among devices such as with Bluetooth® or to a network 134, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 136 or base station 138 used to operatively couple the information handling system 100 to a network 134 and, in an embodiment, to a speakerphone 154 described herein. In a specific embodiment, the network 134 may include macro-cellular connections via one or more base stations 138 or a wireless access point 136 (e.g., Wi-Fi or WiGig), or such as through licensed or unlicensed WWAN small cell base stations 138. Connectivity may be via wired or wireless connection. For example, wireless network access points 136 or base stations 138 may be operatively connected to the information handling system 100. Wireless interface adapter 126 may include one or more radio frequency (RF) subsystems (e.g., radio 128) with transmitter/receiver circuitry, modem circuitry, one or more antenna front end circuits 130, one or more wireless controller circuits, amplifiers, antennas 132 and other circuitry of the radio 128 such as one or more antenna ports used for wireless communications via multiple radio access technologies (RATs). The radio 128 may communicate with one or more wireless technology protocols. In and embodiment, the radio 128 may contain individual subscriber identity module (SIM) profiles for each technology service provider and their available protocols for any operating subscriber-based radio access technologies such as cellular LTE communications.

In an example embodiment, the wireless interface adapter 126, radio 128, and antenna 132 may provide connectivity to one or more of the peripheral devices that may include a wireless video display device 142, a wireless keyboard 144, a wireless mouse 150, a wireless headset, a microphone, an audio headset, the speakerphone 154 described herein, a wireless stylus 146, and a wireless trackpad 148, among other wireless peripheral devices used as input/output (I/O) devices 140.

The wireless interface adapter 126 may include any number of antennas 132 which may include any number of tunable antennas for use with the system and methods disclosed herein. Although FIG. 1 shows a single antenna 132, the present specification contemplates that the number of antennas 132 may include more or less of the number of individual antennas shown in FIG. 1. Additional antenna system modification circuitry (not shown) may also be included with the wireless interface adapter 126 to implement coexistence control measures via an antenna controller in various embodiments of the present disclosure.

In some aspects of the present disclosure, the wireless interface adapter 126 may operate two or more wireless links. In an embodiment, the wireless interface adapter 126 may operate a Bluetooth® wireless link using a Bluetooth® wireless or Bluetooth® Low Energy (BLE). In an embodiment, the Bluetooth® wireless protocol may operate at frequencies between 2.402 to 2.48 GHz. Other Bluetooth® operating frequencies such as Bluetooth® operating frequencies such as 6 GHz are also contemplated in the presented description. In an embodiment, a Bluetooth® wireless link may be used to wirelessly couple the input/output devices operatively and wirelessly including the mouse 150, keyboard 144, stylus 146, trackpad 148, the speakerphone 154 described in embodiments herein, and/or video display device 142 to the bus 116 in order for these devices to operate wirelessly with the information handling system 100. In a further aspect, the wireless interface adapter 126 may operate the two or more wireless links with a single, shared communication frequency band such as with the 5G or WiFi WLAN standards relating to unlicensed wireless spectrum for small cell 5G operation or for unlicensed Wi-Fi WLAN operation in an example aspect. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas 132 may be capable of operating at a variety of frequency bands. In an embodiment described herein, the shared, wireless communication band may be transmitted through a plurality of antennas used to operate in an N×N MIMO array configuration where multiple antennas 132 are used to exploit multipath propagation which may be any variable N. For example, N may equal 2, 3, or 4 to be 2×2, 3×3, or 4×4 MIMO operation in some embodiments. Other communication frequency bands, channels, and transception arrangements are contemplated for use with the embodiments of the present disclosure as well and the present specification contemplates the use of a variety of communication frequency bands.

The wireless interface adapter 126 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, Bluetooth® standards, or similar wireless standards may be used. Wireless interface adapter 126 may connect to any combination of macro-cellular wireless connections including 2G, 2.5G, 3G, 4G, 5G or the like from one or more service providers. Utilization of radio frequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ˜5 MHz frequency band such as 802.11 a/h/j/n/ac/ax (e.g., center frequencies between 5.170-7.125 GHz). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band. For example, low-band 5G may operate at frequencies similar to 4G standards at 600-850 MHz. Mid-band 5G may operate at frequencies between 2.5 and 3.7 GHz. Additionally, high-band 5G frequencies may operate at 25 to 39 GHz and even higher. In additional examples, WWAN carrier licensed bands may operate at the new radio frequency range 1 (NRFR1), NFRF2, bands, and other known bands. Each of these frequencies used to communicate over the network 134 may be based on the radio access network (RAN) standards that implement, for example, eNodeB or gNodeB hardware connected to mobile phone networks (e.g., cellular networks) used to communicate with the information handling system 100. In the example embodiment, the information handling system 100 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end (e.g., antenna front end 130 circuits) of the information handling system 100 may operate on a licensed WWAN wireless radio with authorization for subscriber access to a wireless service provider on a carrier licensed frequency band.

In other aspects, the information handling system 100 operating as a mobile information handling system may operate a plurality of wireless interface adapters 126 for concurrent radio operation in one or more wireless communication bands. The plurality of wireless interface adapters 126 may further share a wireless communication band or operate in nearby wireless communication bands in some embodiments. Further, harmonics and other effects may impact wireless link operation when a plurality of wireless links are operating concurrently as in some of the presently described embodiments.

The wireless interface adapter 126 can represent an add-in card, wireless network interface module that is integrated with a main board of the information handling system 100 or integrated with another wireless network interface capability, or any combination thereof. In an embodiment the wireless interface adapter 126 may include one or more radio frequency subsystems including transmitters and wireless controllers for connecting via a multitude of wireless links. In an example embodiment, an information handling system 100 may have an antenna system transmitter for Bluetooth®, BLE, 5G small cell WWAN, or Wi-Fi WLAN connectivity and one or more additional antenna system transmitters for wireless communication including with the speakerphone 154 described herein. The RF subsystems and radios 128 and include wireless controllers to manage authentication, connectivity, communications, power levels for transmission, buffering, error correction, baseband processing, and other functions of the wireless interface adapter 126.

As described herein, the information handling system 100 may be operatively coupled to a speakerphone 154. The speakerphone 154 may include those devices that allow a user to conduct a conversation with other users remote from the user and speakerphone 154. This is done via a speaker 170 that provides audio to the user of the participants voices remote from the user and one or more microphones 160, 162, 164 on the speakerphone 154. In an embodiment, the speakerphone 154 may be operatively coupled to the information handling system 100 via a wired or wireless connection. In an embodiment where the speakerphone 154 is operatively coupled to the information handling system 100 via a wired connection, the wired connection may provide both data and power to the speakerphone 154. The data sent and received by the speakerphone 154 via the wired connection may include data used to allow the user to communicate via an internet connection such via VOIP. In an embodiment where the speakerphone 154 is operatively coupled to the information handling system 100 via a wireless connection, the speakerphone radio 172 and speakerphone RF front end 174 may be used to provide an operative connection to the information handling system 100 to transceive data between the speakerphone 154 and the radio 128 of the information handling system 100. In another embodiment, the speakerphone 154 may be a stand-alone speakerphone 154 that operates independent of the information handling system 100.

As described herein, the speakerphone 154 includes a first microphone 160, a second microphone 162, and a third microphone 164. Each of these microphones 160, 162, 164 may include a transducer that converts sounds into electrical signals used as input to detect a user's voice and may detect other sounds (e.g., background human voices, vehicle traffic, dog barking, etc.) within the area of the speakerphone 154. During use, in some embodiments, the speakerphone 154 may be used to conduct a teleconference meeting with an MCU 157 managing setup of a call or audio received via the speakerphone radio 172 allowing multiple users or a single user at the speakerphone 154 to talk with other user(s) at a remote location who may also implementing a speakerphone 154 in an example embodiment. The remote participants to the conversation may speak to the local user via microphones on their remotely-located speakerphone with audio being produced at a speaker 170 on the speakerphone 154 to the local user. Concurrently, audio detected by the microphones 160, 162, 164 may be sent to the speaker on the remote speakerphone so that the remote participants of the conversation may hear the voices of the local user(s).

The speakerphone 154 further includes a digital signal processor (DSP) 166. The DSP 166 may be any type of microchip that may be optimized for digital signal processing of the audio data received from the microphones 160, 162, 164 (e.g., electrical signals from the microphones 160, 162, 164). The DSP 166 may be operatively coupled to the microphones 160, 162, 164 such that the electrical signals representing the audio data from the microphones 160, 162, 164 of the voice of the uses may be processed according to the embodiments of the present specification.

The microphones 160, 162, 164 on the speakerphone 154 may, in an example embodiment, include a first microphone 160, a second microphone 162, and a third microphone 164. It is appreciated, however, that the number of microphones at the speakerphone 154 may include two or more. For ease of description and understanding, the present speakerphone 154 is described herein as having three microphones 160, 162, 164. In an embodiment, each of the first microphone 160, second microphone 162, and third microphone 164 are about 60 mm apart from each other and may be distributed on the speakerphone 154 to detect the voice of a user or multiple users. For example, the speakerphone 154 may include a puck-shaped or column-shaped housing with the three microphones 160, 162, 164 distributed at equal angles (e.g., at 120°) around a center of the puck-shaped housing or a top surface of the column-shaped housing. The speakerphone 154 includes an input switch 169 that may be a capacitive touch switch, a key or other switch to switch between a multi-user mode and a single-user mode in embodiments herein.

During operation of the speakerphone 154, each of the microphones 160, 162, 164 detect audio waves of one or more users at varying wave phases. In an embodiment, each of the microphones 160, 162, 164 may always be active and detecting audio (e.g., human voices) from the user participating in a conversation. The sound inputs 178-1, 178-2, 178-3 from the user participating in the conversation may be detected by each of the microphones 160, 162, 164 and the location and direction of the user's voice may be determined via triangulation, trilateration, or multilateration and associated processes based on the varying wave phases detected by the microphones 160, 162, 164.

In an embodiment, a user's voice may be detected, and a directional location of the user may be indicated on an LED strip 168 by an MCU 157 in a single-user mode. This single-user mode may be selected when the user actuates a switch, for example, to toggle the speakerphone 154 from a multi-user mode where more than one participant may engage in the conversation to a single-user mode where all other human voices, as well as background noises, are filtered out of the audio transmitted to a remote location from the speaker phone 154. The lighting of this LED strip 168 may change over time as the user's voice is detected. Again, the audio signals from the microphones 160, 162, 164 may be processed by the DSP 166 and the direction of the user may be determined. When the direction of the user has been determined by the DSP 166, the direction may be set and the LED strip 168 may indicate the direction that the single user's voice is being detected. In an embodiment, this direction of the user may be a voice direction window that indicates an angle from which the user's voice is being detected. The DSP 166 will only process this single user's voice and filter out any other voices or noises that may be detected to not be in the direction of the user's voice by an MCU 157 in a single-user mode. In an embodiment, those human voices and background noises that fall outside of the voice direction window as indicated by the LED strip 168 may be filtered out with less processing from the speakerphone DSP 166. However, in some instances, another human may be behind the user and that other human's voice may fall within the voice direction window. In the example embodiments described herein, these additional human voices detected may also be filtered out by the speakerphone DSP 166 executing a trained acoustic model neural network for voice pattern recognition that recognizes the user's voice (e.g., voice closest to the closest microphone 160, 162, 164) and filters out all other voices. In an embodiment, the trained acoustic model neural network may define characteristics of the user's voice and any other voice that does not have the same or similar characteristics is filtered out. Thus, the filtering of those background voices and noises that fall outside of the voice direction window consume less processing resources with directional voice filtering than the filtering of those voice of other users who may be behind the user but within the voice direction window. This may reduce the processing resources that are consumed while improving the filtering capabilities of the speakerphone 154.

In an embodiment, if and when the user changes position around the speakerphone 154, the DSP 166 may process the user's voice and provide any updated directional information to the MCU 157 to indicate via the LED strip 168 that the direction of the user is being followed. In an embodiment, the DSP 166 may detect when the user has changed position by detecting the amplitude of the user's voice detected at each microphone 160, 162, 164. Where the amplitude of the user's voice detected at any of the first microphone 160, second microphone 162, or third microphone 164 drops below an amplitude threshold the LED strip 168 may provide an indicator that the user's voice is not clear or inaudible. In an embodiment, the LED strip 168 may indicate that the user's voice is clear by displaying a first color (e.g., green) or that the user's voice is inaudible by displaying a second color (e.g., amber). When the amplitude drops, the DSP 166 may also recalculate the direction of the user to determine if a user has moved around the speakerphone 154. Again, this recalculation of the direction of the user around the speakerphone 154 is accomplished by comparing the wave phases of the user's voice at each of the microphones 160, 162, 164 and, via triangulation or trilateration, determine the location of the user around the speakerphone 154. It is appreciated that the user may shift around the speakerphone 154 in a lateral position where a planar two-dimensional (2D) triangulation or trilateration process is conducted. It is further appreciated that the user may change position by sitting down or standing up where the DSP 166 then uses a three-dimensional (3D) triangulation or trilateration process to detect the vertical (and horizontal) change in location of the user. Still further, it is appreciated that the user may move closer to or further away from the speakerphone 154 where a modified planar triangulation or trilateration process is conducted by the DSP 166 to determine the distance of the user away from the speakerphone 154 and which may affect audible levels of voice from the user.

In an embodiment, the sound input 178 of the user's voice is detected when a closest voice to the speakerphone 154 has been determined. The closest voice is determined via a loudness threshold being met or not. For example, a threshold spectral clarity in the voice, a frequency variation threshold, or a combination of these may be used to determine the loudness of the voice in order to compare that loudness to the threshold loudness value. Where the loudness threshold value has been reached, the DSP 166 may indicate this by tracking the voice of the user via the LED strip 168. Additionally, or alternatively, the LED strip 168 may indicate that the threshold loudness level has been reached by displaying a first color (e.g., green) or that the loudness level has not been reached by displaying a second color (e.g., amber). Where the loudness level has not been reached and the LED strip 168 or other indicator indicates that the loudness level has not met the threshold (e.g., lighting of amber light), the user may increase his or her speech level or improve position around (e.g., move closer) the speakerphone.

In an embodiment, the DSP 166 may process the voice of the user to detect characteristics of the user's voice. These characteristics may include, in an example embodiment, an amplitude of the user's voice, a frequency of the user's voice, a pitch of the user's voice, a tone of the user's voice, and pitch duration of the user's voice. The pitch duration of a user's voice may be described as a duration between successive pitch marks in the user's voice. When these features of the user's voice are detected by the DSP 166 processing one or more frames of audio received at the microphones 160, 162, 164, these characteristics may be provided as input, an embodiment, to a trained acoustic model. The trained acoustic model may, in an embodiment, be a neural network that uses any type of machine learning classifier such as Bayesian classifier, a neural network classifier, a genetic classifier, a decision tree classifier, or a regression classifier among others. In an embodiment, the neural network may be in the form of a trained neural network; trained remotely and provided (e.g., wirelessly) to the DSP of the speakerphone 354. The trained neural network may be trained at, for example, a server located on the network operatively coupled to the information handling system or speakerphone 154 and provided to the DSP 166 of the speakerphone 154 in a trained state. The training of the neural network may be completed by the server after receiving a set of audio parameters, extracted audio features, and other data such as the characteristics of users' voices from one or more sources operatively coupled to the server.

In an embodiment, the trained neural network may be a layered feedforward neural network having an input layer with nodes for gathered detected audio parameters, extracted audio features, and other data such as the characteristics of multiple users' voices and other data. For example, the neural network may comprise a multi-layer perceptron neural network executed using the Python® coding language. Other types of multi-layer feed-forward neural networks are also contemplated, with each layer of the multi-layer network being associated with a node weighting array describing the influence each node of a preceding layer has on the value of each node in the following layer.

Via execution of this trained neural network by the DSP 166 during this user's voice characterization, background voices and noise are distinguished within the received audio streams from the microphones 160, 162, 164 and separated from the remaining portions of the microphone audio data streams having the user's voice. This background noise and background human voices may be eliminated leaving the recognized user's voice for transmission of the audio stream to a remote location where remote users are listening to the conversation. In an embodiment, those human voices and background noises that fall outside of the voice direction window 380 as indicated by the LED strip 368 may be filtered out with little processing from the speakerphone DSP. However, in some instances, another human may be behind the user and that other human's voice may fall within the voice direction window. In the example embodiments described herein, these additional human voices detected may also be filtered out by the speakerphone DSP executing a trained acoustic model neural network for voice pattern recognition that recognizes the user's voice (e.g., voice closest to the closest microphone 360, 362, 364) and filters out all other voices. In an embodiment, the trained acoustic model neural network may define characteristics of the user's voice and any other voice that does not have the same or similar characteristics is filtered out. Thus, the voice directional filtering of those background voices and noises that fall outside of the voice direction window may consume less processing resources than the filtering of those voice of other users who may be behind the user but within the voice direction window. This may reduce the processing resources that are consumed increasing the filtering capabilities of the speakerphone 354.

In an embodiment, when the characteristics of the user's voice have been identified, these characteristics may be saved in a speech database that allows the speakerphone 154 to detect the user's voice and associate that voice with that specific user. This allows DSP 166 to specifically identify the user when the user moves around the speakerphone 154 and track voice directionality of the specific user in embodiments herein.

In an embodiment, the speakerphone 154 may further include a speakerphone power management unit (PMU) 158 (a.k.a. a power supply unit (PSU)). The speakerphone PMU 158 may manage the power provided to the components of the speakerphone PMU 158 such as the speakerphone DSP 166, a the MCU 157, speakerphone radio 172, LED strip 168, speaker 170, microphones 160, 162, 164, or other components that may require power when a power button has been actuated by a user on the speakerphone 154. In an embodiment, the speakerphone PMU 158 may monitor power levels and be electrically coupled, either wired or wirelessly, to the information handling system 100. The speakerphone PMU 158 may regulate power from a power source such as a battery or A/C power adapter. In an embodiment, the battery may be charged via the A/C power adapter and provide power to the components of the speakerphone PMU 158 via a wired connections as applicable, or when A/C power from the A/C power adapter is removed.

In an embodiment, the speakerphone 154 may include a speakerphone memory device 156. The speakerphone memory device 156 or other memory of the embodiments described herein may contain computer-readable medium (not shown), such as RAM in an example embodiment. An example of speakerphone memory device 156 includes random access memory (RAM) such as static RAM (SRAM), dynamic RAM (DRAM), non-volatile RAM (NV-RAM), or the like, read only memory (ROM), another type of memory, or a combination thereof. Static memory may contain computer-readable medium (not shown), such as NOR or NAND flash memory in some example embodiments. The applications and associated APIs described herein, for example, may be stored in static memory that may include access to a computer-readable medium such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

The information handling system 100 can include one or more set of instructions 110 that can be executed to cause the computer system to perform any one or more of the methods or computer-based functions disclosed herein. For example, instructions 110 may execute various software applications, software agents, or other aspects or components. Various software modules comprising application instructions 110 may be coordinated by an operating system (OS) 114, and/or via an application programming interface (API). An example OS 114 may include Windows®, Android®, and other OS types known in the art. Example APIs may include Win 32, Core Java API, or Android APIs.

The disk drive unit 118 and may include a computer-readable medium 108 in which one or more sets of instructions 110 such as software can be embedded to be executed by the processor 102 or other processing devices such as a GPU 152 to perform the processes described herein. Similarly, main memory 104 and static memory 106 may also contain a computer-readable medium for storage of one or more sets of instructions, parameters, or profiles 110 described herein. The disk drive unit 118 or static memory 106 also contain space for data storage. Further, the instructions 110 such as audio streaming or teleconference or videoconference applications may embody one or more of the methods as described herein. In a particular embodiment, the instructions, parameters, and profiles 110 may reside completely, or at least partially, within the main memory 104, the static memory 106, and/or within the disk drive 118 during execution by the processor 102 or GPU 152 of information handling system 100. The main memory 104, GPU 152, and the processor 102 also may include computer-readable media.

Main memory 104 or other memory of the embodiments described herein may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The applications and associated APIs described herein, for example, may be stored in static memory 106 or on the drive unit 118 that may include access to a computer-readable medium 108 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In an embodiment, the information handling system 100 may further include a power management unit (PMU) 120 (a.k.a. a power supply unit (PSU)). The PMU 120 may manage the power provided to the components of the information handling system 100 such as the processor 102, a cooling system, one or more drive units 118, the GPU 152, a video/graphic display device 142 or other input/output devices 140 such as the stylus 146, a mouse 150, a keyboard 144, and a trackpad 148 and other components that may require power when a power button has been actuated by a user. In an embodiment, the PMU 120 may monitor power levels and be electrically coupled, either wired or wirelessly, to the information handling system 100 to provide this power and coupled to bus 116 to provide or receive data or instructions. The PMU 120 may regulate power from a power source such as a battery 122 or A/C power adapter 124. In an embodiment, the battery 122 may be charged via the A/C power adapter 124 and provide power to the components of the information handling system 100 via a wired connections as applicable, or when A/C power from the A/C power adapter 124 is removed.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module can also include a combination of the foregoing examples of hardware or software. Note that an information handling system can include an integrated circuit or a board-level product having portions thereof that can also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another can communicate directly or indirectly through one or more intermediaries.

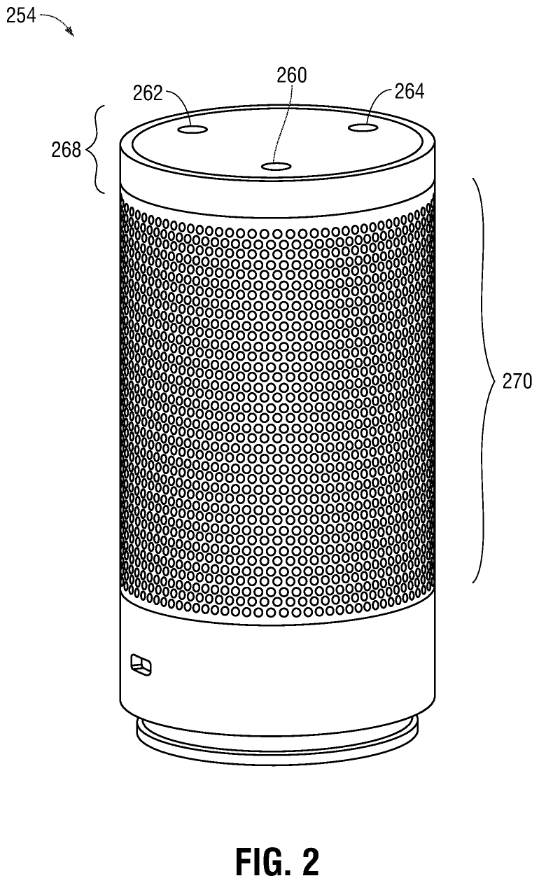

FIG. 2 is a graphic diagram of a speakerphone 254 according to an embodiment of the present disclosure. The embodiment of the speakerphone 254 shown in FIG. 2, the speakerphone 254 includes a column-shaped housing. It is appreciated that this shape of the speakerphone 254 is one of many possible shapes of the speakerphone 154 that may be used, and the present specification contemplates these other shapes of the speakerphone 254. In an embodiment, the speakerphone 254 may be wireless using a speakerphone radio and RF front end to be operatively coupled to, for example, an internet or intranet. In an embodiment, the speakerphone 254 may be operatively coupled to an internet or intranet via a wired connection. In another embodiment, the speakerphone 254 may be operatively coupled to an information handling system either via a wired or wireless connection.

As described herein, the speakerphone 254 may include a speaker 270. The speaker 270 may be placed, in FIG. 2, along an outer surface of the column-shaped housing. As described herein, the speaker 270 is used by the user(s) to hear the voice of remote users during a conversation or to hear other audio streams. In an embodiment, multiple speakers 270 may be placed within the speakerphone 254 in order to provide stereophonic sound to the single user or multiple users.

The speakerphone 254 of FIG. 2 further shows a top portion that includes an LED strip 268. As described herein, the user's voice may be detected and a voice directional location and indicated on an LED strip 268. The lighting of this LED strip 268 may change over time as the user's voice is detected. The DSP described herein will lock in the voice directional location of the user relative to the speakerphone 254 and only process the user's voice while filtering out any other voices that may be determined to not be in the direction of the user's voice. In an embodiment, if and when the user changes position around the speakerphone 254, the DSP may process the user's voice and provide any updated voice directional information to the LED strip 268, via an MCU, indicating that the direction of the user is being followed. Still further, the sound of the user's voice detected when a closest voice to the speakerphone 254 has been determined. The closest voice is determined via a loudness threshold being met or not in an example embodiment. For example, a threshold spectral clarity in the voice of the user, a frequency variation threshold, or a combination of these may be used to determine the loudness of the user's voice in order to compare that loudness to the threshold loudness value. Where the loudness threshold value has been reached, the DSP may indicate this by tracking the voice of the user via the LED strip 268. Additionally, or alternatively, the LED strip 268 may indicate that the threshold loudness level has been reached by displaying a first color (e.g., green) or that the loudness level has not been reached by displaying a second color (e.g., amber).

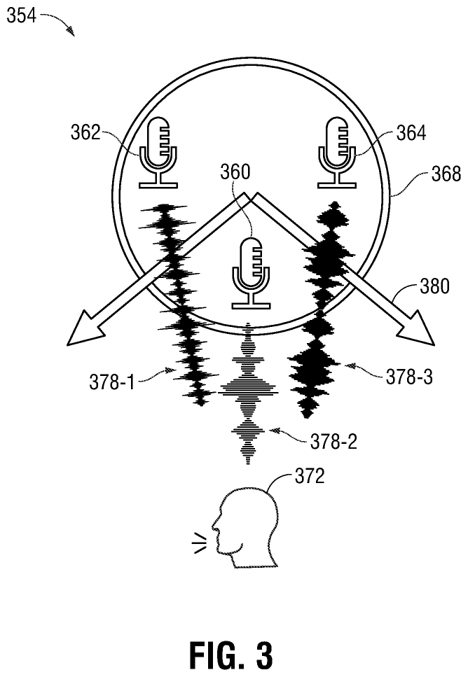

FIG. 3 is a graphic diagram of a top view of a speakerphone 354 according to another embodiment of the present disclosure. FIG. 3 shows the speakerphone 354 where a user 372 has started to talk and the user's voice has been detected by the microphones 360, 362, 364. The user 372 in FIG. 3 is shown to be capable of engaging in a conversation over the speakerphone 354 with one or more of the microphones 360, 362, 364 detecting the user's 372 voice at any location around the speakerphone 354.

Although any users' voice may be detectible by a microphone (e.g., the closest), the user's 372 voice may be detected by any or all of each of the first microphone 360, second microphone 362, and third microphone 364. As described in embodiments herein, the location of the lighting of this LED strip 368 as well as the color of the LED strip 368 may change over time as the user's 372 voice is detected or not and based on audibility levels of the user's voice.

In an embodiment, although the voice of the user 372 is detectible by one or more of the microphones 360, 362, 364 and background noise may be filtered out prior to the audio data being sent remotely from the speakerphone 354. In an example embodiment, a DSP of the speakerphone 354 may first detect the presence and location of the user’ 372 voice and then conduct a noise reduction process to eliminate any background noises or background voices that may be detectable by any of the microphones 360, 362, 364. In an example embodiment, this noise reduction process may include the execution of a neural network that receives, as input, characteristics of the user's 372 voice as well audio parameters, extracted audio features, and other data to recognize and specifically identify the user's voice. The neural network provides, as output, a filtered version of audio that includes only the user's 372 voice and may eliminate background voices that are not recognized as the user's voice. In an embodiment, the neural network may employ any type of machine learning classifier such as Bayesian classifier, a neural network classifier, a genetic classifier, a decision tree classifier, or a regression classifier among others. In an embodiment, the neural network may be in the form of a trained neural network; trained remotely and provided (e.g., wirelessly) to the DSP of the speakerphone 354. The trained neural network may be trained at, for example, a server located on the network operatively coupled to the information handling system or speakerphone 354 and provided to the DSP of the speakerphone 354 in a trained state. The training of the neural network may be completed by the server after receiving a set of audio parameters, extracted audio features, and other data from one or more sources of a specific user's voice operatively coupled to the server. In an embodiment, the trained neural network may be a layered feedforward neural network having an input layer with nodes for gathered detected audio parameters, extracted audio features, and loudness of the user's 372 voice (e.g., loudness threshold being met), and other data. For example, the neural network may comprise a multi-layer perceptron neural network executed using the Python @coding language. Other types of multi-layer feed-forward neural networks are also contemplated, with each layer of the multi-layer network being associated with a node weighting array describing the influence each node of a preceding layer has on the value of each node in the following layer. Via execution of this trained neural network by the DSP during this noise reduction process, background noise and background voices are distinguished within the received audio streams from the microphones 360, 362, 364 and separated from the specific user's voice in the remaining portions of the microphone audio data stream. These background noises and background voices may be eliminated from a specifically identified user's voice before the audio stream is transmitted to a remote location where remote users are listening to the conversation.

During operation, the DSP of the speakerphone 354 may detect characteristics of the user's 372 voice. In an embodiment, when the characteristics of the user's voice have been identified, these characteristics may be saved in a speech database that allows the speakerphone 154 to detect the user's voice and associate that voice with that specific user. This enables the DSP 166 to specifically identify the user and track that user when the user moves around the speakerphone 154. In an embodiment, the characteristics of the user's voice may include an amplitude of the user's voice, a frequency of the user's voice, a pitch of the user's voice, a tone of the user's voice, and pitch duration of the user's voice among others. The pitch duration of a user's voice may be described as a duration between successive pitch marks in the user's voice.

At any time during operation of the speakerphone 354, the DSP of the speakerphone 354 may detect when the user has changed position by detecting the amplitude of the user's voice detected at each microphone 360, 362, 364. Where the amplitude of the user's voice detected at any of the first microphone 360, second microphone 362, or third microphone 364 drops below an amplitude threshold, the DSP may trigger the MCU to indicate if the audibility level has dropped, for example, via an LED strip. Thus, the DSP may recalculate the voice direction window 380 of the user. Again, this recalculation of the direction of the user around the speakerphone 354 is accomplished by comparing the wave phases of the user's voice at each of the microphones 360, 362, 364 and, via triangulation or trilateration, determining the voice direction window 380 of the user around the speakerphone 354. It is appreciated that the user may shift around the speakerphone 354 in a lateral position where a planar 2D triangulation or trilateration process is conducted. It is further appreciated that the user may change position by sitting down or standing up where the DSP then uses a 3D triangulation or trilateration process to detect the vertical (and horizontal) change in location of the user. Still further, it is appreciated that the user may move closer to or further away from the speakerphone 354 where a modified planar triangulation or trilateration process is conducted by the DSP to determine the distance of the user away from the speakerphone 354. The LED indicator indicating that a user's voice is too low or inaudible may indicate the user needs to increase the volume of the user's voice or move closer to the speakerphone 354.

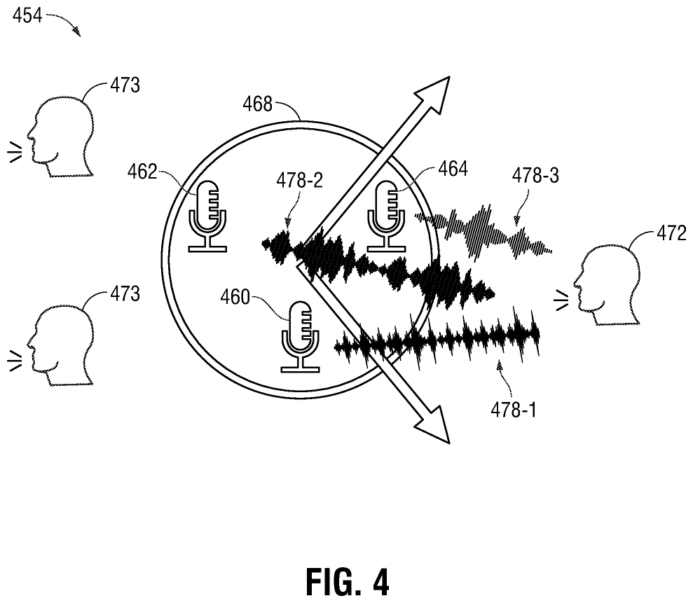

FIG. 4 is a graphic diagram of a top view of a speakerphone 454 showing a second voice direction window 480 according to another embodiment of the present disclosure. FIG. 4 shows the speakerphone 454 has detected the user's 372 voice at a second voice direction window 480 around the speakerphone 454 different from that voice direction window (e.g., 380) detected in FIG. 3. Again, any other background noises or background voices or other persons 473 are not detected that do not meet loudness volume or are not the specifically identified user's voice. In an example embodiment, these background voices/noises do not interfere with a conversation being conducted by the user 472 with remote users of other persons 473. The voice directionality filtering system of embodiments herein may filter background voices based on detected direction not being the user's 472 specific voice direction.

Embodiments of the present specification allow a single user to interact with the speakerphone 454 via detection of the user's 472 voice in a single-user mode. In an embodiment, the sound of the user's 472 voice is received by the first microphone 460, the second microphone 462, and the third microphone 464. The audio signals from the microphones 460, 462, 464 may be processed to determine the differences in the wave phases of the user's 472 voice by the DSP and the voice direction of this single user 472 may be determined as distinct from background voices of other persons 473 in single-user mode. When the voice direction of the single user 472 has been determined by the DSP, the voice direction window 480 may be set and the MCU may cause the LED strip 468 to indicate the voice direction of the single user's voice.

In an embodiment, the DSP will only process this user's 472 voice in single-user mode and filter out any other voices of other persons 473 that may be detected to not be from the voice direction of the user's 472 voice. In an embodiment, if and when the user 472 changes position around the speakerphone 454, the DSP may reprocess the user's voice and the MCU may provide any updated directional information to the LED strip 468 indicating that the voice direction or range of direction of the user 472 is being followed. This reprocessing is accomplished by the DSP of the speakerphone 454 detecting the characteristics of the user's voice and comparing those characteristics saved within a user voice database in an embodiment. The DSP of the speakerphone 454 may recognize the user's voice by comparing characteristics of incoming voice form the user 472 and other persons 473 to the characteristics maintained on the user voice database. When the user 472 has been identified and is a closest or loudest voice, the DSP may continually detect this user's 472 voice and monitor for changes in position of the user 472 while filtering out voice sounds of other persons 473 as described herein.

In an embodiment, the sound of the user's 472 voice is detected when a closest voice or loudest voice to the speakerphone 454 has been determined. The closest voice is determined via a loudness threshold being met or not in an embodiment. In another example, a threshold spectral clarity in the voice, a frequency variation threshold, or a combination of these may be used with volume to determine the loudness of the voice in order to compare that loudness to the threshold loudness value. Where the loudness threshold value has been reached, the DSP may indicate this by locking onto that voice and tracking the voice of the user via the LED strip 468. At this point, the DSP may identify the characteristics of the user's 472 voice and either compare those characteristics to voice characteristics maintained on the user voice database or store those characteristics on the user voice database as a new voice detection to identify the voice of this specific user 472. Additionally, or alternatively, the LED strip 468 may indicate that the threshold loudness level has been reached by displaying a first color (e.g., green). Where the user's 472 voice has been detected, but the loudness level has not been reached or falls below the threshold, the LED strip 468 may display a second color (e.g., amber) indicating that the user may need to increase the volume of the user's 472 voice or move closer in order for their voice to be better detected.

In an example embodiment, a DSP of the speakerphone 454 may also conduct a noise reduction process to filter out any background noises and background voices of other persons 473 that may be detectable by any of the microphones 460, 462, 464. In an example embodiment, this noise reduction process may include the execution of a neural network that receives, as input, characteristics of the user's 472 voice as well audio parameters, extracted audio features, and other data to identify the specific user's voice. Then the voice reduction process provides, as output, a filtered version of audio that includes only the user's 472 voice. In an embodiment, the neural network may employ any type of machine learning classifier such as Bayesian classifier, a neural network classifier, a genetic classifier, a decision tree classifier, or a regression classifier among others.

In an embodiment, the neural network may be in the form of a trained neural network; trained remotely and provided (e.g., wirelessly) to the DSP of the speakerphone 454. The trained neural network may be trained at, for example, a server located on the network operatively coupled to the information handling system or speakerphone 454 and provided to the DSP of the speakerphone 454 in a trained state. The training of the neural network may be completed by the server after receiving a set of audio parameters, extracted audio features, and other data from one or more sources of the specific user's voice operatively coupled to the server. In an embodiment, the trained neural network may be a layered feedforward neural network having an input layer with nodes for gathered detected audio parameters, extracted audio features, loudness of the user's 472 voice (e.g., loudness threshold being met), and other data. For example, the neural network may comprise a multi-layer perceptron neural network executed using the Python® coding language. Other types of multi-layer feed-forward neural networks are also contemplated, with each layer of the multi-layer network being associated with a node weighting array describing the influence each node of a preceding layer has on the value of each node in the following layer.

Via execution of this trained neural network by the DSP during this noise reduction process, background noise and background voices of other persons 473 are distinguished within the received audio streams from the microphones 460, 462, 464 and separated from specific user's voice in the remaining portions of the microphone audio data stream for voice directional filtering may be conducted on voices from other directions. These background noises and background voices of other persons 473 may be eliminated based on voice direction before the audio stream is transmitted to a remote location where remote users are listening to the conversation. Again, in an embodiment, those human voices and background noises that fall outside of the voice direction window as indicated by the LED strip 468 may be filtered out with less processing from the speakerphone DSP. However, in some instances, another human 473 may be behind the user and that other human's voice may fall within the voice direction window. In another example embodiments described herein, these additional human voices detected may also be filtered out by the speakerphone DSP executing a trained acoustic model neural network for voice pattern recognition that recognizes the user's 472 voice (e.g., voice closest to the closest microphone 460, 462, 464) and filters out all other voices. In an embodiment, the trained acoustic model neural network may define characteristics of the user's 472 voice and any other voice that does not have the same or similar characteristics is filtered out. In this way, the filtering of those background voices and noises that fall outside of the voice direction window may consume fewer processing resources than the filtering of those voice of other users who may be behind the user but within the voice direction window. This may reduce the processing resources that are consumed increasing the filtering capabilities of the speakerphone 454.

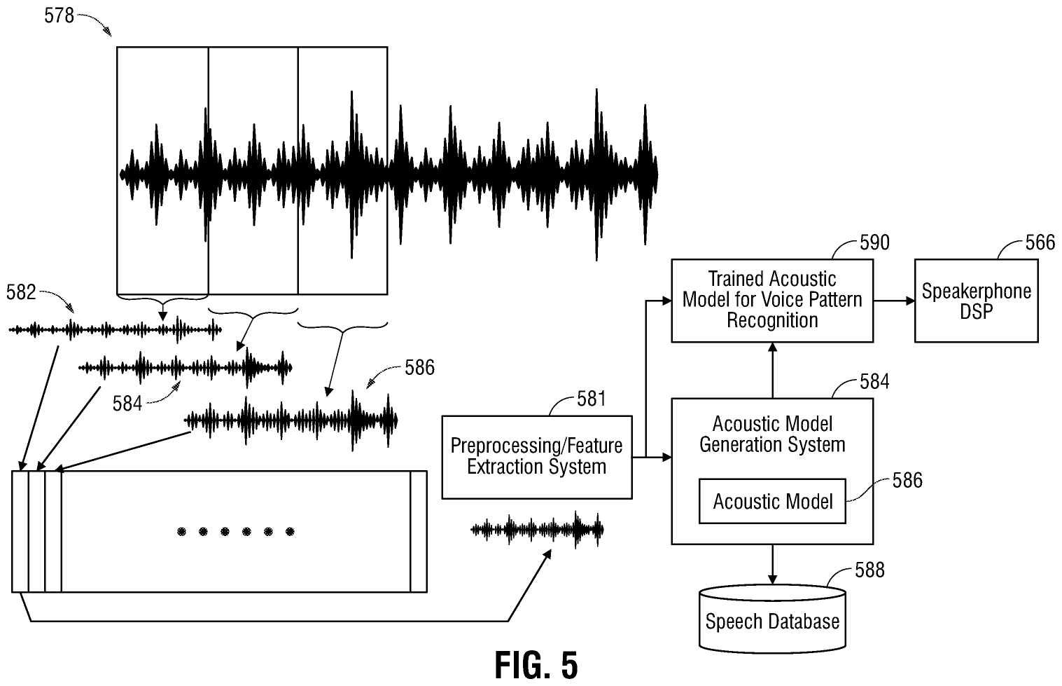

FIG. 5 is a diagram describing a method of detecting and processing speech, via a DSP 566, from a user captured by a plurality of microphones of the speakerphone according to an embodiment of the present disclosure. It is appreciated that this process may be conducted after the speakerphone has detected the user's voice, a loudness threshold of the user's voice has been reached, and the DSP 566 is processing the user's voice, via the execution of a trained acoustic model, to detect characteristics of the user's voice.

With the trained neural network, the DSP system may then lock onto voice detection of the specific user and use this voice direction to filter out other background voice from other directions according to embodiments herein. With the specific user voice identification, the DSP may then track the specific user's voice as the user moves around the speakerphone according to embodiments herein. Finally, although potentially more computationally intensive, the specific identification of a user's voice may be used to filter out background voices (e.g., from the same direction) to further filter the user's voice in some embodiments.

FIG. 5 shows a section of voice audio 578 detected by at least one of the plurality of microphones described herein. In an embodiment, each of the microphones may detect the user's voice and produce a similar section of voice audio 578 any of which may be used to process for voice characterizations of a user's voice to train a neural network or to be used by a trained neural network to continually identify a single user's voice in embodiments. In an example embodiment, the section of voice audio 578 may be a section of audio received by the closest microphone, but it is appreciated that the section of voice audio 578 used in this method may come from any of the plurality of microphones in the speakerphone 154.

During operation, the DSP 566 may extract one or more audio frames from the section of voice audio 578. An audio frame may be a portion of the entire section of voice audio 578 and may be seconds, microseconds, or nanoseconds long. In an embodiment, a frame 582, 584, 586 may be long enough for the DSP 566 to, via the neural network described herein, detect characteristics of the user's voice as described herein. FIG. 5 shows that a first frame 582, a second frame 584, and a third frame 586 have been extracted from the section of voice audio 578, however, it is appreciated that any number or a continuous number of frames 582, 584, 586 may be extracted to process for characteristics of a user's voice for inputs to train the neural network or to use with a trained neural network.

A frame 582, 584, 586 or multiple frames 582, 584, 586 of the section of voice audio 578 may be provided to a preprocessing/feature extraction system 581. The preprocessing/feature extraction system 581 may extract from each frame 582, 584, 586 those characteristics of the user's voice to be input to the neural network. These characteristics may include, in an example embodiment, an amplitude of the user's voice, a frequency of the user's voice, a pitch of the user's voice, a tone of the user's voice, and pitch duration of the user's voice. The pitch duration of a user's voice may be described as a duration between successive pitch marks in the user's voice. The preprocessing/feature extraction system 581 may detect these characteristics and, in an embodiment, create a trained acoustic model 586 at a neural network model generation system 584. The acoustic model 586 may, in an embodiment, be a neural network that uses any type of machine learning classifier such as Bayesian classifier, a neural network classifier, a genetic classifier, a decision tree classifier, or a regression classifier among others. In an embodiment, the neural network may be in the form of a trained neural network that was trained remotely and provided (e.g., wirelessly) to the DSP 566 of the speakerphone. The neural network acoustic model 586 may be trained at, for example, a model generation system 584 at a server located on the network operatively coupled to the information handling system or speakerphone and provided to the DSP 566 of the speakerphone in a trained state at 590. The training of the neural network may be completed by a processor of a server executing a model generation system 584 (e.g., hardware or firmware executing computer readable program code) after receiving a set of audio parameters, extracted audio features, and other data such as the characteristics of the user's voice from one or more sources operatively coupled to the server. In an embodiment, the trained neural network of the trained acoustic model for voice pattern recognition 590 may be a layered feedforward neural network having an input layer with nodes for gathered detected audio parameters, extracted audio features, and other data such as the characteristics of multiple users' voices and other data. For example, the trained neural network of the trained acoustic model for voice pattern recognition 590 may comprise a multi-layer perceptron neural network executed using the Python® coding language. Other types of multi-layer feed-forward neural networks are also contemplated, with each layer of the multi-layer network being associated with a node weighting array describing the influence each node of a preceding layer has on the value of each node in the following layer. Via execution of this trained neural network of the trained acoustic model for voice pattern recognition 590 by the DSP 566 during this user's voice characterization, background voices and noise are distinguished within the received audio streams from the microphones and separated from the specifically identified user's voice portion of the microphone audio data streams from the microphones to enable the DSP 566 to lock onto the user's voice and its voice direction. This background noise and background human voices may then be eliminated based on the voice direction before the audio stream is transmitted to a remote location where remote users are listening to the conversation. This voice direction filtering may save processing resources when filtering out background voices (e.g., voices not located within a voice direction location of the user).

When the characteristics of the user's voice have been identified, these characteristics may be stored in a speech database 588. This this speech database 588 may be maintained on, for example, a memory device on the speakerphone. During operation, the data maintained on the speech database 588 may be used to identify the user's voice for tracking even when the user moves around the speakerphone. The trained neural network pattern classification system 590 may be executed by a DSP 566, in an example embodiment, to classify the user's voice, in real time, as the user is speaking for tracking and for voice direction filtering. This classification allows the DSP 566 to continuously detect and determine that the user's voice is being detected so that the DSP 566 can follow the user's voice if and when the user moves around the speakerphone.

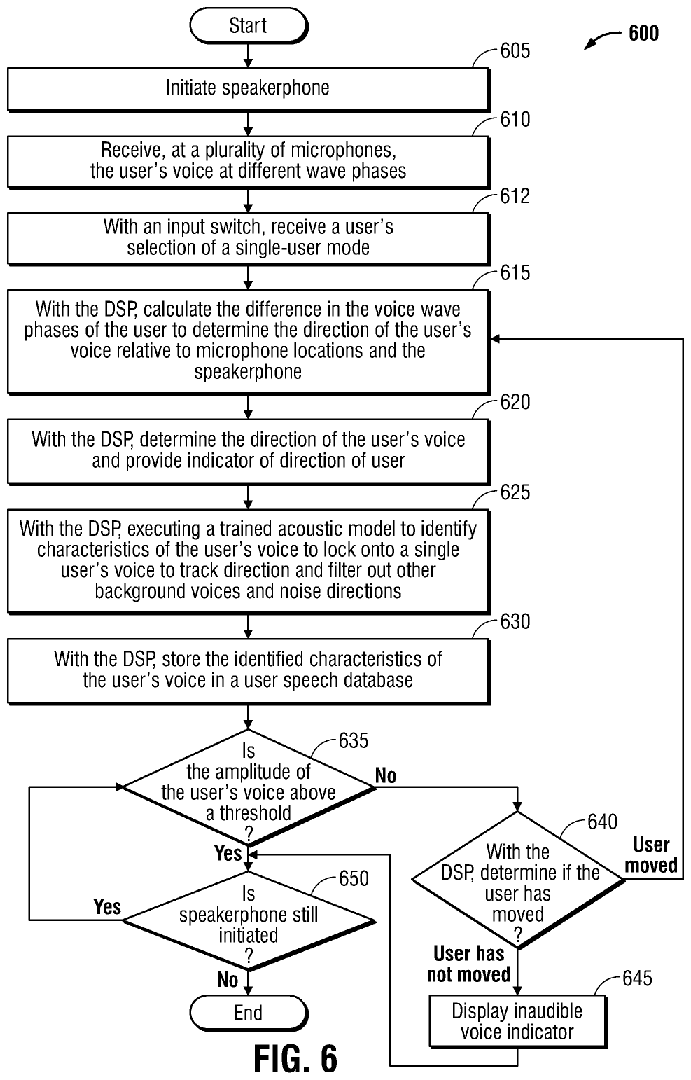

FIG. 6 is a flow diagram of a method 600 of operating a speakerphone according to an embodiment of the present disclosure. As described herein, the speakerphone may or may not be operatively coupled to an information handling system that may be used to facilitate the speakerphone in communicating to other speakerphones remote to the local speakerphone. Alternatively, the speakerphone may be a stand-alone device that communicates with remote speakerphones via, for example, an internet connection using VOIP.

The method 600 may include, at block 605, the initiation of the speakerphone. This initiation may include pressing a power button or operatively coupling a PMU of the speakerphone to a power source such as a battery or an A/C power source. This initiation process may include the execution of a native BIOS, a native OS, or other code instructions used and executed by the DSP to cause the speakerphone to process audio data and perform the methods described herein.

When initiated, the method of operating the speakerphone includes, at block 610, receiving, at a plurality of microphones, the user's voice at different wave phases. As described herein, the speakerphone includes a plurality of microphones (e.g., three microphones) that are located at certain locations on the speakerphone. Because the relative distance and angles around the speakerphone between these microphones is known, as the user's voice is received by each of these microphones, the sound as detected by each microphone is out of phase of one another. This allows the location of the user, relative to the speakerphone, to be determined via triangulation or trilateration including 2D trilateration or 3D trilateration according to embodiments herein. In some embodiments, more than three microphones may be used, and it is contemplated that 2D or 3D multilateration may be used based on microphone locations and signal phases, time, distance, or other aspects of multiple user voice signals.

At bock 612, the DSP of the speakerphone may receive input from an input switch indicating a user's selection of a single-user's mode. As described herein, the use may use this input switch to toggle between a multi-user mode and the single-user mode. The multi-user mode may allow multiple users to concurrently engage in a conversation at the speakerphone during, for example, a teleconference session. The single-user mode, in the embodiments herein, may allow a single use to use the speakerphone to engage in a teleconference session, for example, while background noises and background voices are filtered out according to the processes and methods described herein.

The method 600 continues at block 615 with calculating the difference in the voice wave phases of the user to determine the direction of the user's voice relative to the microphone locations within the speakerphone with the DSP. As described herein, each of the plurality of microphones may be positioned away from each other on the speakerphone so that each microphone receives the single user's voice at different times resulting in a difference in the wave phases of the single user's voice. This process may include any 2D and/or 3D triangulation process, trilateration process, or multilateration process to determine an angular direction of the user's voice and, accordingly, the voice direction of the user around the speakerphone.

At block 620, the method may include determining the direction of the user's voice and providing an indicator (e.g., via a LED strip) of the direction of that user relative to the speakerphone. Again, each of the microphones of the speakerphone may detect audio waves of the single user at varying wave phases due to the location of the user relative to each of the microphones. In an embodiment, each of the microphones may always be active and detecting audio (e.g., human voices) from the user participating in a conversation. The sound inputs from the user participating in the conversation may be detected by each of the microphones and the location and direction of the user's voice may be determined via triangulation, trilateration, or multilateration based on the varying wave phases and other aspects of user voice or sound signals detected by the microphones.

The method 600 may further include executing a trained acoustic model to identify characteristics of the user's voice with the DSP at block 625. In this process, the DSP may extract from each frame of a section of voice audio those characteristics of the user's voice. These characteristics may include, in an example embodiment, an amplitude of the user's voice, a frequency of the user's voice, a pitch of the user's voice, a tone of the user's voice, and pitch duration of the user's voice. The pitch duration of a user's voice may be described as a duration between successive pitch marks in the user's voice.

In an embodiment, the DSP may execute a preprocessing/feature extraction system that detects these characteristics and, in an embodiment, create a trained acoustic model at a model generation system. The trained acoustic model may, in an embodiment, be a neural network that uses any type of machine learning classifier such as Bayesian classifier, a neural network classifier, a genetic classifier, a decision tree classifier, or a regression classifier among others. In an embodiment, the neural network may be in the form of a trained acoustic model neural network for voice pattern recognition that was trained remotely and provided (e.g., wirelessly) to the DSP of the speakerphone. The trained acoustic model neural network for voice pattern recognition may be trained at, for example, a model generation system at a server located on the network operatively coupled to the information handling system or speakerphone and provided to the DSP of the speakerphone in a trained state. The training of the trained acoustic model neural network for voice pattern recognition may be, in an embodiment, completed by a processor of a server executing a model generation system (e.g., hardware or firmware executing computer readable program code) after receiving a set of audio parameters, extracted audio features, and other data such as the characteristics of users' voices from one or more sources operatively coupled to the server.

In an embodiment, the trained acoustic model neural network for voice pattern recognition may be a layered feedforward neural network having an input layer with nodes for gathered detected audio parameters, extracted audio features, and other data such as the characteristics of multiple users' voices and other data. For example, the trained acoustic model neural network for voice pattern recognition may comprise a multi-layer perceptron neural network executed using the Python® coding language. Other types of multi-layer feed-forward neural networks are also contemplated, with each layer of the multi-layer network being associated with a node weighting array describing the influence each node of a preceding layer has on the value of each node in the following layer. Via execution of this trained acoustic model neural network for voice pattern recognition by the DSP during this user's voice characterization, the user's voice is distinguished from background voices and background noise within the received audio streams from the microphones as described herein.

As described herein, all other background voices and background noises detected by any of the microphones is considered background noise that is to be filtered out from the audio data of the user's voice, but other background voices are not as effectively filtered. The method 600 includes locking in, based on the identified user's voice, the direction of the single user's voice. With the DSP locking in the voice direction or voice direction window of where the single user's voice is from, the DCP may process voices at that direction while filtering out other background voices and background noises from different direction windows. In other words, this directional voice filtering process includes filtering out other human voices from different directions detected to be around or near the speakerphone that are not within the user's voice direction window. Thus, in an example embodiment, this noise reduction process may lock onto the specifically identified voice of the user which may then be processed at the voice direction that the DSP determines for the single user and filter out any other background voices of other people that may be located around the speakerphone based on other voices coming from different directions. In this way, background voices may be reduced with DSP processing efficiency. Thus, background noise and background voices may be eliminated before the audio stream is transmitted to a remote location where remote users are listening to the conversation.

In a further aspect, the background noise reduction process may include the execution of the trained neural network acoustic model for voice pattern recognition among a user's voice and other background voices and distinguish those. Via execution of this trained acoustic model neural network for voice pattern recognition by the DSP during this noise reduction process or filtering process, background voices may be distinguished within the received audio streams from the microphones and separated from the remaining portions such as a user's voice and background voices of the microphone audio data stream from the microphones. Via execution of this trained acoustic model neural network for voice pattern recognition by the DSP during this user's voice characterization, background voices and background noise may also be distinguished within the received audio streams from the microphones and separated from the remaining portions of the microphone audio data streams from the microphones as described herein. However, separating background voices in this way may be computationally more intensive. However, additional background human voices, such as from a same direction, may further be eliminated before the audio stream is transmitted to a remote location where remote users are listening to the conversation.

The method 600 may further include storing the identified characteristics of the user's voice in a user speech database at block 630. This this speech database may be maintained on, for example, a memory device on the speakerphone. During operation, the data maintained on the speech database may be used to identify the user's voice even when the user moves around the speakerphone. The pattern classification system of the trained acoustic model neural network may be executed by the DSP, in an example embodiment, to classify the user's voice, in real time, as the user is speaking. This classification allows the DSP to continuously detect and track the direction from which the user's voice is being detected so that the DSP can follow the user's voice if and when the user moves around the speakerphone. In this way, the DSP may continue to filter other voices based on voice directionality even when the user may move around the speakerphone and between angular fields of coverage of the plural microphones in an embodiment.

In an embodiment, the DSP may calculate a signal power of the user's voice descriptive of the decibel levels of the user's voice that describes the amplitude of the user's voice. At block 635, the DSP may determine whether the amplitude of the user's voice meets or exceeds an amplitude threshold. In an embodiment, an average decibel level may be determined to fall within one or more decibel range levels including, for example, decibel range of levels designated as “loud,” “normal,” and “soft.” This average decibel level may place the signal power of any given user's voice within these categories. This average may be taken over a period of time (e.g., 1 second, 5 seconds, 10 second, etc.) and dynamically places the decibel levels of the users' voices within one of these categories. At this point, the average loudness (e.g., amplitude) of any given user's voice may be compared to a threshold level that may include a low decibel threshold and/or a high decibel threshold where, for example, the low threshold is the “soft” category, and the high threshold is the “loud” category. Additionally, as described herein, a threshold spectral clarity in the voice, a frequency variation threshold, or a combination of these may also be used by the DSP to determine the loudness of the voice in order to compare that loudness to the threshold loudness value. The spectral clarity of any given user's voice may include harmonic centroid (a weighted center mass of energy of a sound spectrum) and spectral inconsistencies related to sharp peaks roughly in the middle of the frequencies detected spectrum. The frequency variation may be descriptive of variability of the frequency of any given user's voice. It is appreciated that the number of audio frames (length of audio detected) used to determine the loudness, spectral clarity, and or frequency variation thresholds may vary depending on the processing resources of the DSP or other processing devices within the speakerphone or accessible to the speakerphone (e.g., a processing resource of the information handling system). The smaller the audio frames, the more processing resources may be required to calculate the loudness threshold described herein.

Where, at block 635, the DSP has determined that the amplitude of the user's voice has not met the threshold, the method 600 continues to block 640 with the DSP determining if the user has moved to a different location around the speakerphone. This is determined by the DSP when the DSP has detected a drop in amplitude, below the threshold, of the user's voice as detected by any of the microphones but particularly at a closest microphone in an embodiment. In an embodiment, this may be accompanied by an increase in amplitude of the user's voice at one or more microphones further indicative that the user has moved position around the speakerphone and out of the angular field of coverage of a closest microphone. If it is determined that the user has moved, then the method 600 returns to lock 615. If it is determined that the user has not moved, then the method may continue to block 645 as described herein.

At block 645, the method 600 includes displaying an inaudible voice indicator via, in an example embodiment, an LED strip as described herein, the LED strip may provide an indicator that the user's voice is not clear or inaudible. As part of the determination of loudness, both voice signal volume amplitude as well as spectral clarity aspects may be determined to have fallen below a threshold loudness level. In such an embodiment, the LED strip may indicate that the user's voice is clear by displaying a first color (e.g., green) if above the loudness threshold, or, as in block 645, display an indicator that the user's voice is inaudible by displaying a second color (e.g., amber).

When the method 600 returns to block 615, the method 600 continues with the DSP recalculating the difference in wave phases of the user's voice and locking in a direction of the user (e.g., blocks 615 and 620). Again, this recalculation of the direction of the user around the speakerphone is accomplished by comparing the wave phases of the user's voice at each of the microphones and, via triangulation or trilateration, determine the location of the user around the speakerphone. It is appreciated that the user may shift around the speakerphone in a lateral position where a planar 2D triangulation or trilateration process is conducted. It is further appreciated that the user may change position by sitting down or standing up where the DSP then uses a 3D triangulation or trilateration process to detect the vertical (and horizontal) change in location of the user. Still further, it is appreciated that the user may move closer to or further away from the speakerphone where a modified planar triangulation or trilateration process is conducted by the DSP to determine the distance of the user away from the speakerphone.

Where the amplitude of the user's voice has been determined to be at or above the threshold at block 635, the method 600 continue to block 650 with determining whether the speakerphone is still initiated. Again, the speakerphone is initiated where power to the speakerphone has been provided and the speakerphone has not been shut down. Where the speakerphone is still initiated, the method 600 returns to block 635 with the determination as to whether the amplitude of the user's voice is at or above a threshold. Where the speakerphone is no longer initiated, the method 600 may end.

The blocks of the flow diagrams of FIG. 6 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A speakerphone comprising:
a memory device;
a power management unit (PMU);
a first microphone to receive audio waves;
a second microphone to receive audio waves;
a third microphone to receive audio waves;
a digital signal processor (DSP) to:
process the audio waves received by the first microphone, second microphone, and third microphone to determine the wave phases of the audio waves received by the first microphone, second microphone, and third microphone to calculate a voice direction of a voice of a user relative to the speakerphone;
lock in the voice direction of the user relative to the speakerphone; and
process the voice of the user to detect characteristics of the user's voice and filter out background noises and background voices from outside an angular field coverage for the voice direction of the user.

2. The speakerphone of claim 1 further comprising:
the DSP to compute a loudness of the user's voice at a closest microphone of the first, second, and third microphones to determine whether the direction of the user's voice relative to the angular field coverage from the speakerphone has changed.

3. The speakerphone of claim 1 further comprising:
saving the characteristics of the user's voice within a user voice database for the speakerphone to recognize the user's voice.

4. The speakerphone of claim 1 further comprising:
a light-emitting diode (LED) strip indicating the angular field coverage for the voice direction including the direction of where the user's voice is detected.

5. The speakerphone of claim 1 further comprising:
the DSP to execute a level detector system by:
detecting whether a loudness of the user's voice averaged over a duration of that user's voice amplitude falls below a loudness threshold; and
an LED strip providing feedback indicating to the user whether the user's voice is audible or not at a closest microphone of the first microphone, the second microphone, and the third microphone.

6. The speakerphone of claim 1 further comprising:
the DSP executing a trained acoustic model to process the voice of the user to detect characteristics of the user's voice to identify the voice of the user by providing a plurality of frames of the audio as input to the trained acoustic model; and
the DSP locking onto the identified voice of the user to track voice direction of the user.

7. The speakerphone of claim 1, wherein calculating a direction of a voice of a single user by the DSP includes calculating a difference in the wave phases of the audio waves received at the first microphone, second microphone, and third microphone to determine the direction of the user's voice relative to the first microphone, second microphone, and third microphone arranged at a set distance from each other in a housing of the speakerphone.

8. A directional voice detection speakerphone, comprising:
a memory device;
a power management unit;
a plurality of microphones to receive audio waves;
a digital signal processor (DSP) executing code instructions to:
process the audio waves received by a first microphone, a second microphone, and a third microphone to determine the wave phases of the audio waves received by the first microphone, the second microphone, and the third microphone to calculate a voice direction of a voice of a user relative to the speakerphone;
process, by executing a trained acoustic model, the voice of the user to detect characteristics of the user's voice by providing a plurality of frames of the audio as input to the trained acoustic model and determine a voice identification of the voice of the user;
lock in the voice direction of the user relative to the speakerphone based on the voice identification of the user's voice; and
filter out background voices of other persons that are not determined to be the voice identification of the user's voice based on the locked voice direction of the user for transmission of the user's voice in an audio signal.

9. The directional voice detection speakerphone of claim 8 further comprising:
the DSP computing a loudness level of the user's voice at a closest microphone determined from the first microphone, the second microphone, and the third microphone to determine whether the direction of the user's voice relative to the speakerphone has changed.

10. The directional voice detection speakerphone of claim 8 further comprising:
the characteristics of the user's voice including an amplitude, a frequency, a pitch, a tone, and pitch duration.

11. The directional voice detection speakerphone of claim 8 further comprising:
a light-emitting diode (LED) strip indicating an angular field coverage including the voice direction of where the user's voice is detected.

12. The directional voice detection speakerphone of claim 8 further comprising:
the DSP to execute an audible level detector system by comparing the loudness of the user's voice to a loudness threshold; and
an LED strip providing feedback to the user indicating whether the user's voice is audible or not at a closest microphone selected among the first microphone, the second microphone, and the third microphone.

13. The directional voice detection speakerphone of claim 8 further comprising:
the memory device saving the characteristics of the user's voice within a user voice database for the speakerphone to recognize the user's voice with the voice identification.

14. The directional voice detection speakerphone of claim 8, wherein calculating a voice direction of a voice of a user by the DSP includes calculating a difference in the wave phases of the audio waves received at the first microphone, the second microphone, and the third microphone to determine the voice direction of the user's voice based on the first microphone, the second microphone, and the third microphone arranged at a set distance and angle from each other in a housing of the speakerphone.

15. A method of operating a speakerphone comprising:
receiving audio at a first microphone, a second microphone, and a third microphone;
with a digital signal processor (DSP):
processing audio waves of a user's voice received by the first microphone, second microphone, and third microphone to determine the wave phases of the audio waves and calculating a direction of a voice of a user relative to the speakerphone;
locking in the voice direction of the user relative to the speakerphone;
processing the voice of the user to detect characteristics of the user's voice and directionally filtering out background noises and background voices from outside and angular field coverage based on the voice direction of the user; and
transmitting the directionally filtered user's voice in an audio signal via a network coupling.

16. The method of claim 15 further comprising:
with the DSP, computing a loudness of the user's voice to determine whether the voice direction of the user's voice relative to the speakerphone has changed if the loudness of the user's voice falls below a loudness threshold.

17. The method of claim 15 wherein the characteristics of the user's voice include an amplitude, a frequency, a pitch, a tone, and pitch duration.

18. The method of claim 15 further comprising:
with the DSP, detecting a loudness level of the user's voice and an average duration of that loudness;
determining if the loudness level of the user's voice falls below a loudness threshold; and
providing feedback to the user indicating whether the user's voice is audible at the closest microphone selected from the first microphone, the second microphone, and the third microphone.

19. The method of claim 15 further comprising:
with the DSP, executing a trained acoustic model to process the voice of the user to detect characteristics of the user's voice for an identification of the user's voice among a received voice signal by providing a plurality of frames of the voice signal as input to the trained acoustic model.

20. The method of claim 15, wherein calculating a voice direction of a voice of the user by the DSP includes calculating a difference in the wave phases of the audio waves received at the first microphone, second microphone, and third microphone to determine the direction of the user's voice, the first microphone, second microphone, and third microphone arranged at a set distance from each other in a housing of the speakerphone.
